(19) United States
(12) Patent Application Publication
(10) Pub. No.: US 2010/0087229 A1
(43) Pub. Date: Apr. 8, 2010

(54) MECHANICAL DESIGN OF DISPLAY

(75) Inventor: Matti MAATTA, Apex, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/247,489

(22) Filed: Oct. 8, 2008

(51) Int. Cl. H04M 1/00; G09G 3/30

(52) U.S. Cl. 455/566; 345/76

(57) ABSTRACT

A mobile phone is provided with a symmetric display package that maximizes the available display active area for a given display footprint, and permits placement of the active area of the display in the horizontal and/or vertical center lines of the device.

### TECHNICAL FIELD OF THE INVENTION

The present invention relates generally to electronic devices, and more particularly, to electronic devices, such as portable communication devices, with displays.

### DESCRIPTION OF THE RELATED ART

Portable communication devices, and in particular mobile telephones, are used for a wide variety of applications. For example, mobile phones are used not only for phone conversations and for sending/receiving messages, but also for browsing the internet, viewing multimedia content, such as movies or music, and for playing games, etc.

In general, the display screen on a mobile phone is limited by the overall size of the phone. As mobile phones are reduced in size, the surface area available for the display screen, functional keys and a keypad is reduced. The display size is also limited by design requirements that dictate the amount of space adjacent the viewable portion of the screen that is needed for connections between the screen and the processor and/or video adapter of the mobile phone.

Typical displays are constructed so that the connector(s) is on one edge of the display. This results in an asymmetric display package that often does not complement a symmetric device design, and results in a display footprint (e.g., the areal extent of the device) that is substantially larger than the active area of the display.

### SUMMARY

To enhance functionality and versatility, a mobile phone is provided with a symmetric display package that maximizes the available display active area for a given display footprint, and permits placement of the active area of the display in the horizontal and/or vertical center lines of the device.

One aspect of the disclosed technology relates to a display for an electronic device comprising a display screen for displaying an image, and a connector connected to the display screen along opposing edges thereof and extending across at least a portion of a non-viewing side of the display screen.

According to another aspect, the connector is a flex circuit.

According to another aspect, the flex circuit is contained within the footprint of the display.

According to another aspect, the connector is connected to the display on an underside thereof.

According to another aspect, the display further comprises at least one component mounted on a non-viewing side of the display screen.

According to another aspect, the at least one component is includes a connector or a display driver.

According to another aspect, the display is an organic light emitting diode (OLED) display.

According to another aspect, the display is a bottom emitting OLED display.

According to another aspect, the display further comprises a display substrate supporting the display screen, wherein the display screen is symmetrically positioned on the substrate with at least one edge of the display screen aligned with an edge of the substrate.

According to another aspect, an electronic device includes the display.

According to another aspect, the display screen is located at a centerline of the electronic device.

According to another aspect, the electronic device is a mobile phone.

According to another aspect, the electronic device is at least one of a personal audio device, a personal video device or a personal digital assistant.

According to another aspect, a bottom-emitting OLED display comprises a transparent substrate, at least one OLED light emitting elements including a first electrode formed on a bottom side of the substrate, an OLED light emissive layer located over the first electrode, and a second electrode located over the OLED light emissive layer, and a connector connected to the substrate on the bottom side thereof.

According to another aspect, the connector is a flex circuit, and the flex circuit is contained within a footprint of the display.

According to another aspect, the display further comprises at least one electrical component mounted on a non-viewing side of the display.

According to another aspect, an electronic device includes the bottom-emitting OLED display.

According to another aspect, the display is located at a centerline of the electronic device.

According to another aspect, the electronic device is a mobile phone.

According to another aspect, the electronic device is at least one of a personal audio device, a personal video device or a personal digital assistant.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a top view of a prior art display.

FIG. 2 is a top view of an exemplary display in accordance with the invention.

FIG. 3 is bottom view of the display of FIG. 2.

FIG. 4 is another top view of the exemplary display of FIG. 2.

FIG. 5 is a top view of a mobile phone including the exemplary display of FIGS. 2-4, in accordance with the invention.

FIG. 6 is an exploded view of the basic components of the display of FIGS. 2-4.

FIG. 7 is a detailed exploded view of the components of the display of FIGS. 2-4.

FIG. 8 is schematic cross-sectional view of an exemplary bottom-emitting OLED in accordance with the invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form. Certain terminology is used herein to describe the different embodiments of the invention. Such terminology is used only for convenience when referring to the figures. For example, “upward” or “downward” and the like merely describe directions in the configurations shown in the figures. The components can be oriented in any direction and the terminology should therefore be interpreted to include such variations.

As referred to herein, the term “portable communication device” includes portable radio communication equipment. The term “portable radio communication equipment,” which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like.

In the context of the illustrated embodiments, the portable communication device is primarily referred to as a mobile telephone or a mobile phone. The description and illustrations of the mobile telephone, however, are intended to serve as a non-limiting exemplary environment for the inventive concepts described herein, and it will be appreciated that the invention is not intended to be limited to a mobile telephone, but rather can be any type of electronic equipment.

The present disclosure recognizes shortcomings with conventional displays, including displays of portable communication devices, and provides a portable communication device (e.g., a mobile phone) having symmetric display.

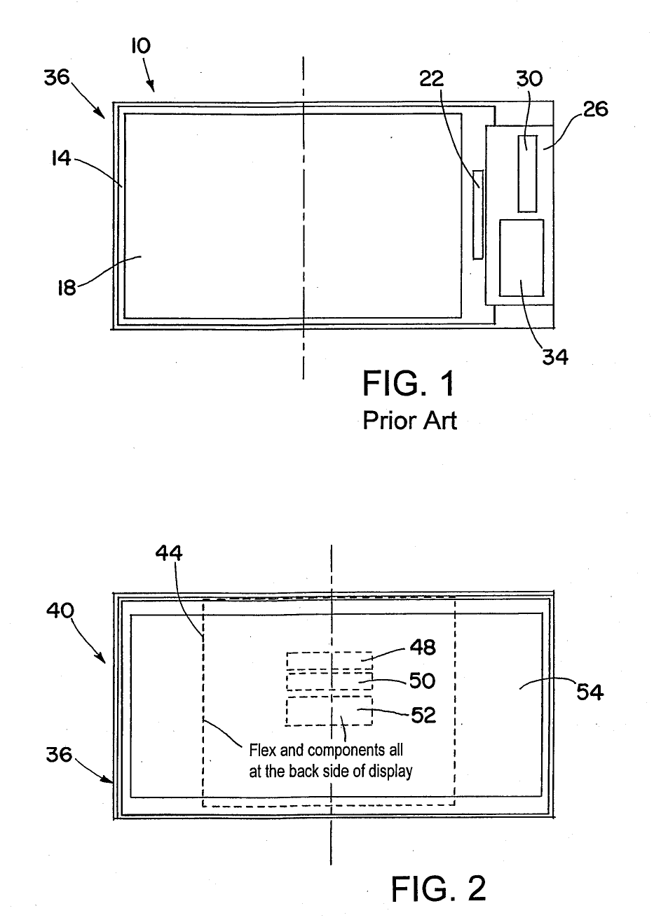

Referring initially to FIG. 1, a prior art display is indicated generally by reference numeral 10. The display 10, which may be an LCD or an OLED display for example, includes a substrate 14, a display screen (viewable area) 18 supported on the substrate 14, a display driver 22, and a flex circuit 26 including connecter 30 and various other components 34. As will be appreciated, the display driver 22 and flex circuit 26 are located on the side of the substrate 14, as is conventional. The flex 26 is attached to the front side (e.g., the viewing side) of the display screen 18 along the right edge thereof. Typically, since the flex circuit 26 extends outwardly from the display 10, when the display 10 is installed in a device the flex circuit 26 will be bent underneath the display. This results in wasted space and in the display package being asymmetric. Further, the display footprint 36 is larger than the active area (viewable area of display screen 18) of the display 10 in order to accommodate the flex circuit.

Turning to FIG. 2, and in accordance with the invention, a display 40 is illustrated wherein the active area of the display screen is considerably larger for the same size device footprint 36. The display 40 includes a flex 44, display driver 48, connector 50 and other components 52 located on the back side (non-viewing side) of the display screen 54. This design results in a symmetric display package wherein the active area of the display is more closely sized to that of the device footprint.

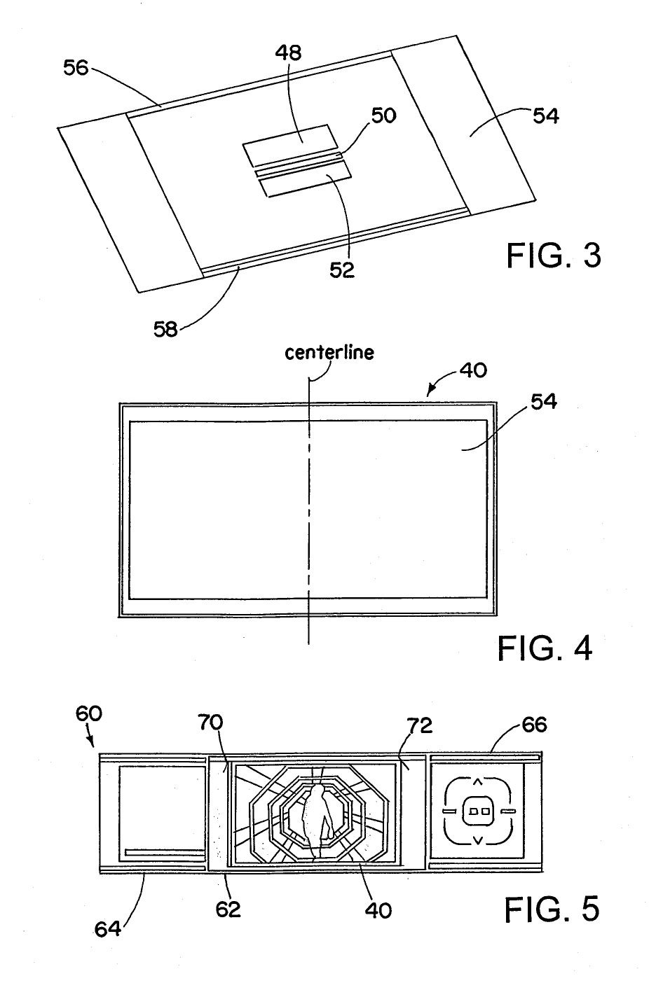

In FIG. 3, which is a bottom view of the display 40, the display 40 is a bottom emitting OLED display and the flex circuit 44 is connected to respective opposite edges 56 and 58 of the display 40. Accordingly, the flex circuit is oriented inwardly towards the center of the display 40 and no space is wasted in bending the flex circuit 44 around as the display as in the prior art.

With reference to FIGS. 4 and 5, the resulting display 40 is generally symmetrical, offering a viewing area (display screen) that is centered about the device footprint. This makes it possible to stretch the display almost to the edge of the mechanics of a device, for a fuller and more balanced appearance.

For example, in FIG. 5 an exemplary display 40 in accordance with the invention is shown in a mobile phone 60. The mobile phone 60 has a housing 62 that supports the display 40 and a pair of wing portions 64 and 66 that slide out from underneath the display 40. Each wing portion 64 and 66 has thereon at least one input device, such as a touchpad or directional pad or the like, for the input of information by a user. Slide mechanisms (not shown), facilitate movement of the wing portions 64 and 66 and are also contained within the housing 62. The exemplary display 40 facilitates a symmetrical design that permits left and right speakers 70 and 72 to be placed immediately adjacent the display 40, in a location that in the past would be occupies by the flex circuit and/or driver of a display.

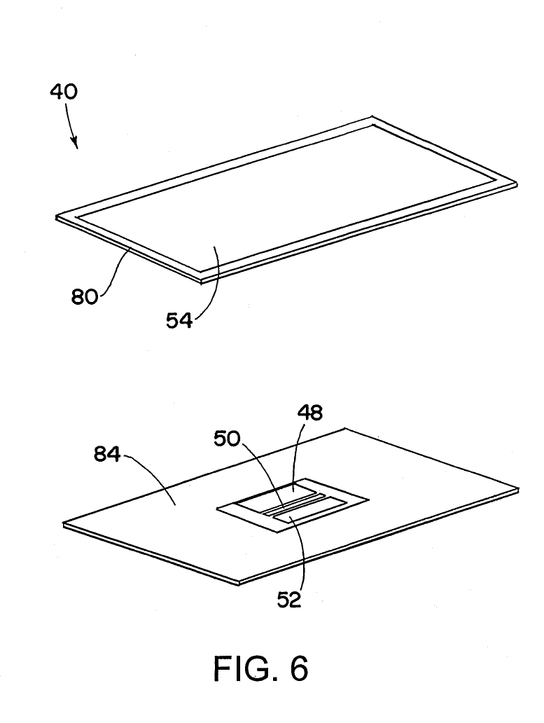

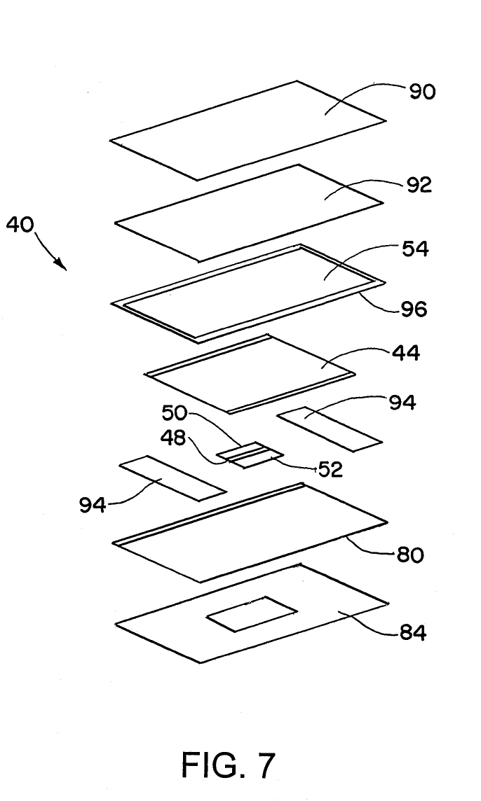

Turning now to FIGS. 6 and 7, and initially to FIG. 6, the construction of the exemplary display 40 is illustrated. In its basic form, the display 40 includes a bottom emitting OLED display screen 54 supported on a suitable frame 80, while display driver 48, connector 50, and components 52 are supported on a metal frame 84. More particularly, and with reference to FIG. 7, the display 40 includes the following layers/components: a cover glass 90, an adhesive layer 92, a bottom emitting OLED display 54, a flex circuit 44, adhesive pads 94, connector 50, display driver 48, components 52, plastic frame 80 and metal frame 84.

It will be appreciated that some existing bottom emitting OLED displays are a particularly well-suited display type for use in the present invention. This is because conventional bottom emitting OLED generally have a substrate 96 that is larger than the active portion of the screen 54. This feature of bottom-emitting OLED dislplays facilitates connection of the flex to opposing sides of the display screen on the non-viewing side thereof, and allows the display screen 54 to be centered within the device footprint. Accordingly, the frame of such display device can extend equally on all sides as desired to achieve a generally symmetrical display package.

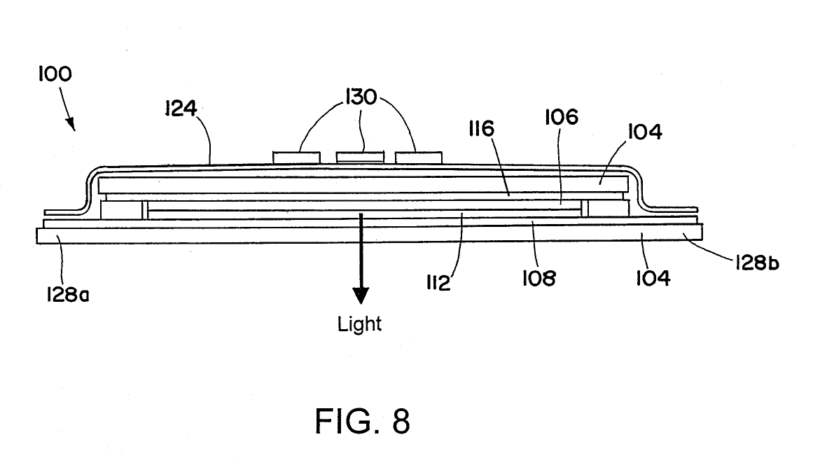

For example, and with reference to FIG. 8, an exemplary bottom emitting OLED is illustrated at 100. The display 100 includes a first (top) and second (bottom) transparent substrates 104, first and second electrodes 106 and 108, and an OLED light emissive layer 112 located between the first and second electrodes 106 and 108. The illustrated OLED 100 is generally conventional except with respect to the location and attachment of a flex circuit 124, as will now be described.

As will be appreciated, the bottom substrate 104 is larger than the top substrate and the active area (e.g., the OLED light emissive layer 112) of the display 100. Accordingly, portions 128a and 128b of the substrate 104 generally extend beyond the upper substrate 104. While in the past a flex circuit and connectors etc. would be attached to one or the other portions 128a or 128b, in accordance with the invention the flex circuit 124 is secured to opposing edges of the bottom substrate 104 in the regions of portions 128a and 128b on the underside (or bottom or non-viewing side) of the display 100. Accordingly, the flex circuit 124, along with driver 130 and other components, are within the footprint of the display 100, and result in a symmetric display as described previously.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A display for an electronic device comprising:
a display screen for displaying an image; and
a connector connected to the display screen along opposing edges thereof and extending across at least a portion of a non-viewing side of the display screen.

2. A display as set forth in claim 1, wherein the connector is a flex circuit.

3. A display as set forth in claim 2, wherein the flex circuit is contained within the footprint of the display.

4. A display as set forth in claim 1, wherein the connector is connected to the display on an underside thereof.

5. A display as set forth in claim 1, further comprising at least one electrical component mounted on a non-viewing side of the display screen.

6. A display as set forth in claim 1, wherein the at least one electrical component includes a connector or a display driver.

7. A display as set forth in claim 1, wherein the display is an organic light emitting diode (OLED) display.

8. A display as set forth in claim 7, wherein the display is a bottom emitting OLED display.

9. A display as set forth in claim 1, further comprising a display substrate supporting the display screen, wherein the display screen is symmetrically positioned on the substrate with at least one edge of the display screen aligned with an edge of the substrate.

10. An electronic device including the display as set forth in claim 1.

11. An electronic device as set forth in claim 10, wherein the display screen is located at a centerline of the electronic device.

12. An electronic device as set forth in claim 10, wherein the electronic device is a mobile phone.

13. An electronic device as set forth in claim 10, wherein the electronic device is at least one of a personal audio device, a personal video device or a personal digital assistant.

14. A bottom-emitting OLED display comprsing:
a transparent substrate,
at least one OLED light emitting elements including a first electrode formed on a bottom side of the substrate, an OLED light emissive layer located over the first electrode, and a second electrode located over the OLED light emissive layer; and
a connector connected to the substrate on the bottom side thereof.

15. A bottom-emitting OLED display as set forth in claim 14, wherein the connector is a flex circuit, and wherein the flex circuit is contained within a footprint of the display.

16. A bottom-emitting OLED display as set forth in claim 14, further comprising at least one electrical component mounted on a non-viewing side of the display.

17. An electronic device including the display as set forth in claim 14.

18. An electronic device as set forth in claim 17, wherein the display is located at a centerline of the electronic device.

19. An electronic device as set forth in claim 14, wherein the electronic device is a mobile phone.

20. An electronic device as set forth in claim 14, wherein the electronic device is at least one of a personal audio device, a personal video device or a personal digital assistant.
